(19) United States
(12) Patent Application Publication
(10) Pub. No.: US 2008/0046741 A1
(43) Pub. Date: Feb. 21, 2008

(54) Protecting signatures using collision-resistant hash functions

(75) Inventor: Ilya Mironov, Mountain View, CA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/504,553

(22) Filed: Aug. 14, 2006

(51) Int. Cl. H04L 9/00

(52) U.S. Cl. 713/176

(57) ABSTRACT

A message is hashed with a first hash function to generate a first hashed message, and then the first hashed message is hashed with a second hash function to generate a second hashed message. The second hashed message is then signed. The first hash function may be a domain extender, such as a TCR (target-collision resistant) hash. The second hash function may be a random oracle. The second hash function may be slower than the first hash function. A signature scheme such as DSA, PSS-RSA, or Cramer-Shoup may be used.

### BACKGROUND

Computers and communications networks require data security tools that are highly secure and highly efficient. Users expect that sensitive computerized data transferred via electronic means remains confidential, maintains its integrity, and is verifiably authentic. Parties transmitting messages and data to one another should be able to determine if alterations have occurred in transit. Likewise, these parties must be able to verify the origin of messages. Digital signature schemes require that anyone can verify that a signature is the real or valid signature of the signer for an associated message. Likewise, just as with handwritten signatures, these schemes require that only the signer of a signed message be able to generate a particular signature.

Developers rely on the concept of the “hash” or hash function when designing signature schemes, particularly when designing signature algorithms. Hash functions or hash algorithms are employed as a way of creating small digital “fingerprints” from any kind of data. The created fingerprint is a new chopped and mixed value, called a hash value, whose unique value is dependent upon the original data.

Hash functions are commonly incorporated as part of “hash-and-sign” signature schemes, where the message to be signed is hashed using a cryptographic hash function. Hash-and-sign signature schemes are no more secure than the underlying hash function on which they rely. Conventional schemes have recently come under numerous and formidable attacks.

### SUMMARY

A message is hashed with a first hash function to generate a first hashed message, and then the first hashed message is hashed with a second hash function to generate a second hashed message. The second hashed message is then signed. The first hash function may be a domain extender, such as a TCR (target collision-resistant) hash. The second hash function may be a random oracle. The second hash function may be slower than the first hash function. A signature scheme such as DSA, PSS-RSA, or Cramer-Shoup may be used.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a diagram of a signature scheme that may be used to authenticate messages between a sender and a receiver.

FIG. 2 is a diagram of an example of a hash-and-sign signature scheme.

FIG. 3 is a flow diagram of an example signature method.

FIG. 4 is a diagram of components of an example hash-and-sign signature scheme.

FIG. 5 is a diagram of components of another example hash-and-sign signature scheme.

FIG. 6 is a block diagram of an example computing environment in which example embodiments and aspects may be implemented.

### DETAILED DESCRIPTION

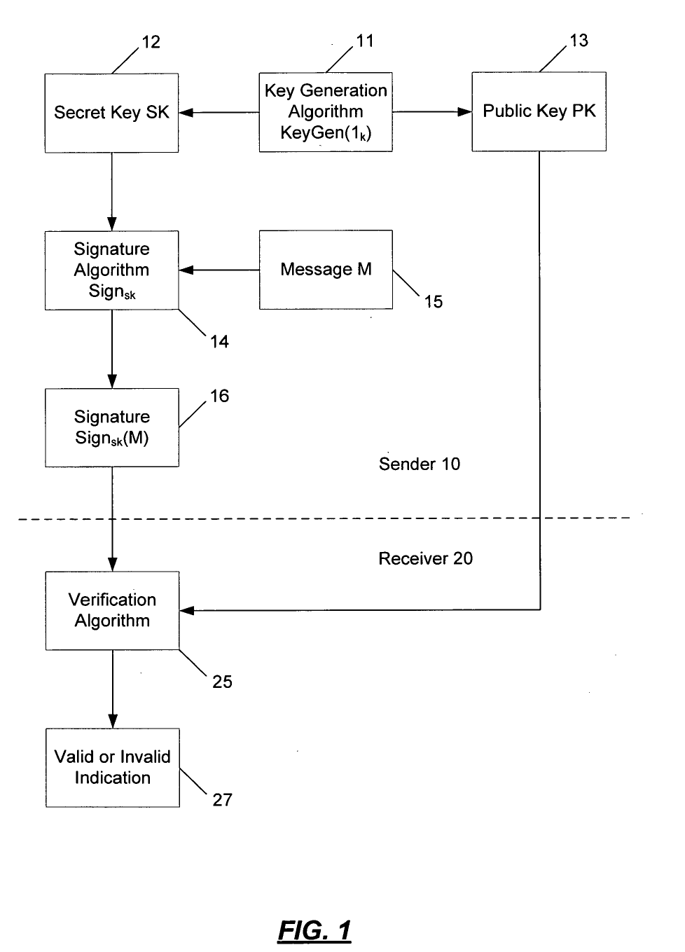

A signature scheme generally consists of a triple of mathematical algorithms to achieve authenticity and integrity of data. FIG. 1 represents a sender-recipient digital signature scheme used to send, receive, and authenticate messages. A sender 10 attempts to send a message to a receiver 20. Initially, a key generation algorithm 11, KeyGen(1ₖ), is used by the sender 10 to generate a secret key (SK) 12 and a public key (PK) 13. The public key 13 is made available to the receiver 20 by any of wide variety of communication mechanisms. The sender 10 keeps the secret key 12 secret.

To authenticate a given message (M) 15, the sender 10 utilizes a signing algorithm 14, Signₛₖ. The algorithm 14 uses as its input the message 15 and the secret key 12. The output of the signing algorithm 14 is a signature 16 on the message 15. The sender 10 then sends both the message 15 and the signature 16 to the receiver 20 using a known communication technique.

The receiver 20 then uses a verification algorithm 25, Verifyₚₖ(σ, M), to verify and accept the message. The receiver 20 completes the verification process by giving the verification algorithm 25 as input the public key 13, the message 15, and the signature 16. The output 27 of the verification algorithm 25 signifies whether the signature is valid or an invalid signature has been detected.

A feature of many hash functions is that they act as random functions. These hash functions generate output that does not have any easily discernable pattern, so that the sequence can be treated as being random. Another attribute of some hash functions is that one hash function may act slower than another. For example, one hash function may act in an order of magnitude faster than another hash function in terms of its ability to hash data. The real world application domain of hash functions currently includes MAC or message authentication code and public-key encryption, for example.

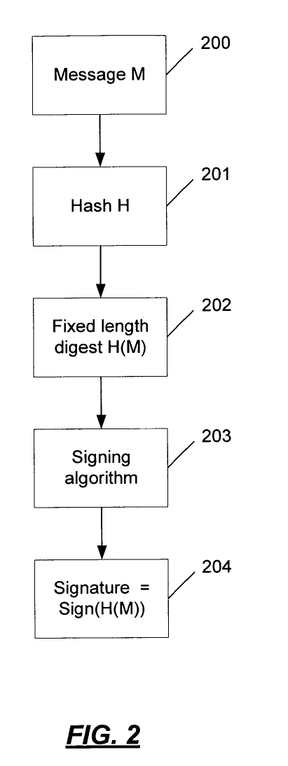

Many practical signature schemes are constructed according to the hash-and-sign paradigm. As in FIG. 2, these signature schemes rely on exposing any arbitrary length message (M) 200 to a “hash” or hash function (H) 201 that turns an arbitrary length message into a fixed length digest H(M) 202, and then exposing that digest to another algorithm called a signing algorithm (Sign) 203 which outputs a signature (Sign(H(M))) 204. As part of the hash-and-sign process, many hash functions create their own fresh randomness as part of their output.

Many current hash-and-sign signature schemes rely on collision-resistant hash functions (CRHs). A hash function is collision-resistant if it is hard to find two inputs that hash to the same output. Complicating the use of CRHs is the fact that they are notoriously hard to construct and validate. A hash-and-sign signature scheme that does not rely on complex CRHs would be highly desirable. Furthermore, numerous and formidable recent attacks on a variety of conventional collision-resistant hash functions have called into question the hash-and-sign paradigm in general. A hash-and-sign solution that would divest signature schemes of their reliance on collision-resistant hash functions is desirable. Bypassing the requirement of using CRHF in signature schemes would make signatures more robust and potentially increase their efficiency.

Hash-and-sign signature schemes may make use of two types of hash functions. The first is the aforementioned collision-resistant hash function. The second type of hash function that can be used is called a target collision-resistant hash function (TCR). These functions are known to be a useful class of universal one-way hash functions or UOWHF. It is well established that provably secure signature schemes can be constructed from one-way functions. Both types of hash functions serve to create digital “fingerprints” of any kind of data fed into them, but target collision-resistant hash functions are based on weaker security primitives and are therefore easier to create. Designing hash-and-sign signature schemes with security primitives that are easier to design is appealing and an ever-present goal of digital signature scheme developers.

Target collision-resistant hash functions are called “keyed” functions. These functions rely on the signer generating a random key k that is output with the results of the hash function that in combination become parts of the hash-and-sign signature. A limitation surrounding the use of TCRs is that because the key is appended to the results of the function there is an increase of overall signature size. Existing methods of using TCRs in digital signature schemes increases signature length. Because computer systems must efficiently process numerous signatures, a hash-and-sign signature scheme which makes use of a TCR hash but which does not generate additional signature length is desirable.

Hash functions in signature schemes may play the role of domain extender. The concept of a domain extender relies on the idea that a worthwhile signature scheme desirably is able to accept arbitrary length input to be useful. However, applying conventional signature schemes to messages of unrestricted length inputs exposes the signature schemes to trivial forgeries. A hash function that is a domain extender removes this weakness based on a well-established generic concept that there are functions that can transform a compression function (or a function which maps fixed length input into fixed length output) with fixed length input into a hash function with arbitrary input. The so-called Merkle-Damgard is the most commonly used domain extender. A hash-and-sign signature scheme that incorporates the use of a hash function that is a domain extender is desirable.

Hash functions in signature schemes may play the role of random oracle. A purpose of a random oracle is to assist in proving a signature scheme's security. That is, if one seeks to show that in order to break a protocol that an attacker must engage in impossible attacking behavior or solve a mathematical problem believed hard to solve, they might use a random oracle or random oracle model in their proof of security. Random oracles are included in proofs of security where the proof requires that the hash function's output show strong randomness and there are no real functions (or at least not ones that can be implemented) providing sufficient mathematical properties to satisfy the proofs of security.

Many known digital signature schemes use the random oracle model and are provably secure in that model. Most notable are the DSS and PSS-RSA schemes. Notably, not all cryptographic hash functions require random oracle behavior. Some schemes only require the property of collision resistance to be provably secure. These schemes are provably secure without the use of random oracles, and are therefore categorized as secure in the “standard model”. One of the most notable schemes provable in the “standard model” is the Cramer-Shoup cryptosystem. A hash-and-sign signature scheme that incorporates the use of a hash function that is a random oracle is desirable. Similarly, a hash-and-sign scheme that incorporates a function secure in the standard model is useful as well.

Hash-and-sign hash functions are provided that incorporate the properties of a random oracle and TCRs without increasing overall signature length. The techniques use cryptographic hash functions called efficient TCRs. These hash functions map, as part of their keyed output, a randomly generated key in combination with the results of the function.

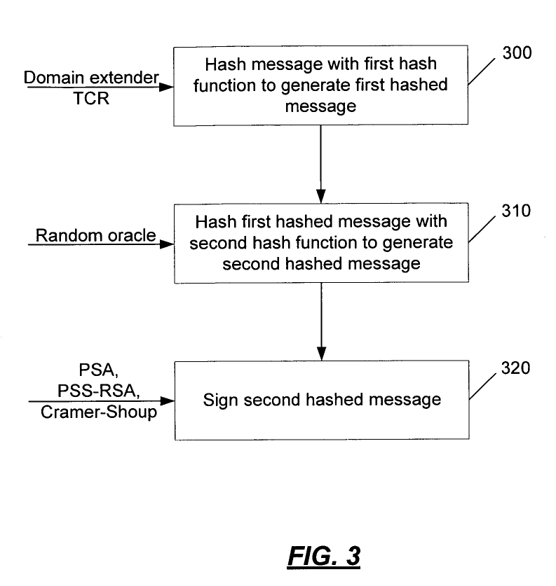

FIG. 3 is a flow diagram of an example signature method. At step 300, a message is hashed with a first hash function to generate a first hashed message. The first hash function may be a domain extender. For example, the first hash function may be a TCR hash.

At step 310, the first hashed message is hashed with a second hash function to generate a second hashed function. The second hash function may be a random oracle. The second hash function may be slower than the first hash function

At step 320, the second hashed message is signed. Signing the second hashed message may use a DSA, PSS-RSA, or Cramer-Shoup signature scheme, for example.

More particularly, hashing the message with the first hash function at step 300 may comprise hashing the message M with an independently keyed TCR hash function Hₖ to generate the first hashed message (Hₖ(M)). At step 310 in this example, hashing the hashed message with a second hash may comprise hashing (Hₖ(M)) with a random oracle hash function F to generate the second hashed message (F(Hₖ(M))). An example of signing the second hashed message at step 320 comprises signing (F(Hₖ(M))) with a randomly generated key k to generate a signed message in the form of {k, Sign(F(k, Hₖ(M))} or {k, Sign(F(Hₖ(M))}.

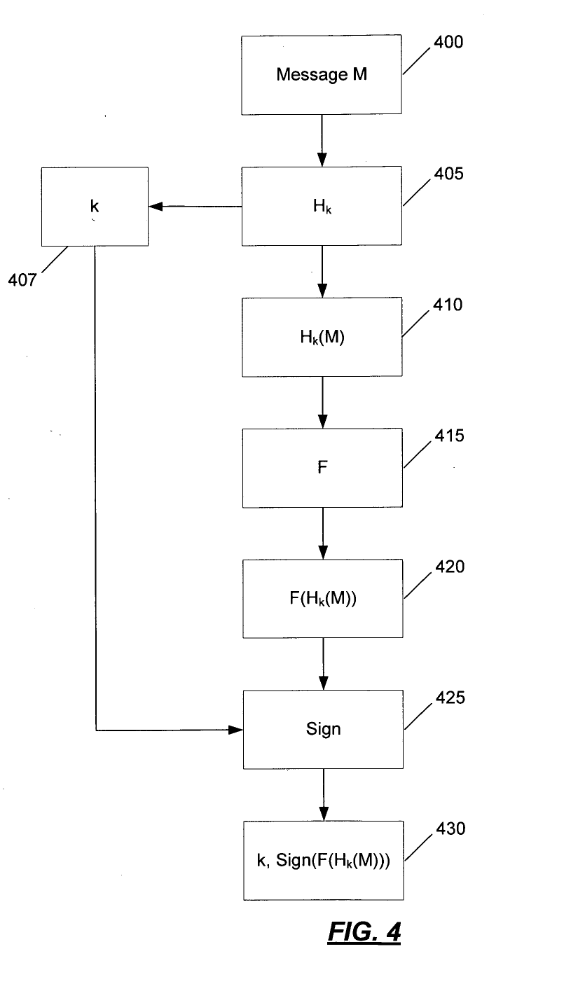

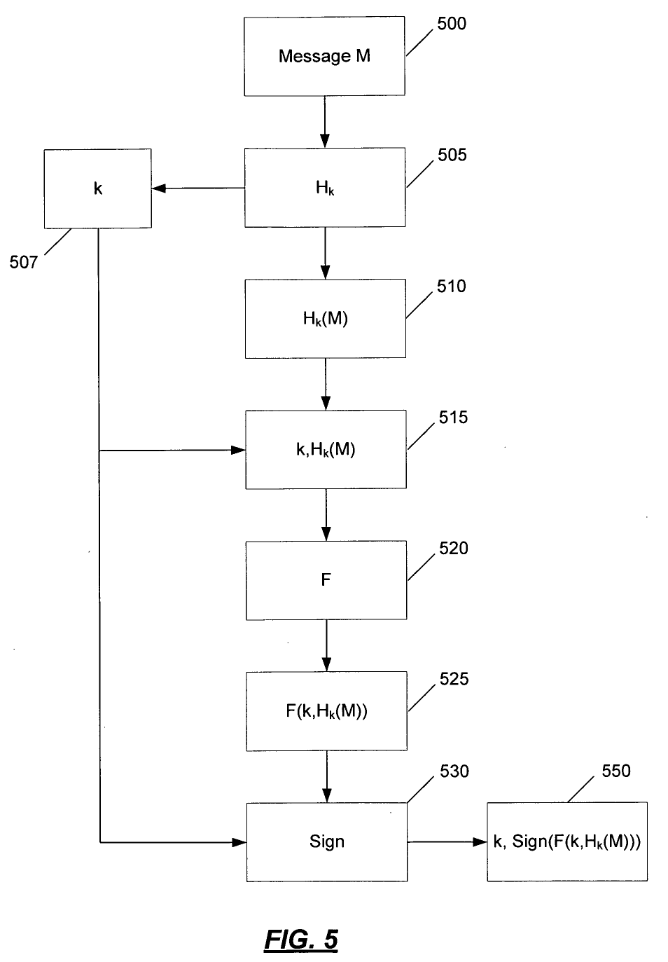

FIGS. 4 and 5 shows components of example hash-and-sign signature schemes for hashing an arbitrary message M. The hash process can be represented as F(Hₖ(M)). For example, the message is fully hashed by first feeding it into an independently keyed TCR hash function Hₖ before feeding it into a slower random oracle function F.

In FIG. 4, a message M 400 is hashed by an independently keyed TCR hash function Hₖ 405. The result of the hashed message is a key 407 and a first hashed message 410. The results of the TCR hash in some permutations may be represented as k, Hₖ, where k is a key. Owing to the nature of hash functions in general, this key k borne of the TCR has randomness freshly generated each time it is created. This randomness is generated independent of the actual message that assisted in its genesis.

Subsequently, the first hashed message 410 is fed into the slower function F 415, generating a second hashed message 420. The function F may be modeled as a random oracle. Desirably, the random oracle is conservatively designed with fixed length input and output.

A signing algorithm 425 integrates the results of the hash portion of the scheme with the keyed portion of the scheme thereby creating the signature. The signing algorithm Sign 425, which could be DSA, PSS-RSA, or Cramer-Shoup, for example, subsequently completes the hash-and-sign scheme by combining the earlier generated key 407 and the second hashed message 420, providing the signature 430 as its result.

FIG. 5 shows components of another example hash-and-sign signature scheme. Here, the message M 500 is hashed by an independently keyed TCR hash function 505, for example. The result of the hashed message is a key 507 and the first hashed message 510. Subsequently the combination 515 of the key 507 and the first hashed message 510 are fed into a slower random oracle 520, generating a second hashed message 525.

A signing algorithm 530 which could be DSA, PSS-RSA, or Cramer Shoup, for example, subsequently completes the hash-and-sign scheme by combining the earlier generated key 507 and the second hashed message 525, providing the signature 550 as its result.

The signing process can be represented as k, Sign(F(Hₖ(M)) as in FIG. 4 or as k, Sign(F(k, Hₖ(M))) as in FIG. 5. FIG. 5 may be the desired signature scheme when it is desirable to be secure under a certain class of attacks, called weak forgeries, where adversaries succeed if the are able to create new valid signatures on a message where the message is already signed by the legitimate signer.

By using TCRs, the signature scheme is no longer reliant on difficult to construct and questionably secure CRH. Additionally, use of TCR hash functions, as opposed to use of CRH, drastically reduces construction time on secure signature schemes. Furthermore, for DSA and PSS-RSA in the random oracle model and for the Cramer-Shoup signature scheme in the standard model, use of the TCR-based constructions are as provably secure as prior CRH-based constructions.

Due to the use of the randomly generated key data of the TCR functions, keylength expansion of signature schemes that make use of TCR functions may not be an issue. In other words, the signature length is not increased by the use of a TCR hash. Specifically, some of the randomly generated data produced by various TCR functions are reused as randomness required by the signature scheme and output as part of the signature. Therefore, for methods making use of TCR functions such as herein described, there would be reduced computing time processing TCR-based signature schemes.

### Exemplary Computing Arrangement

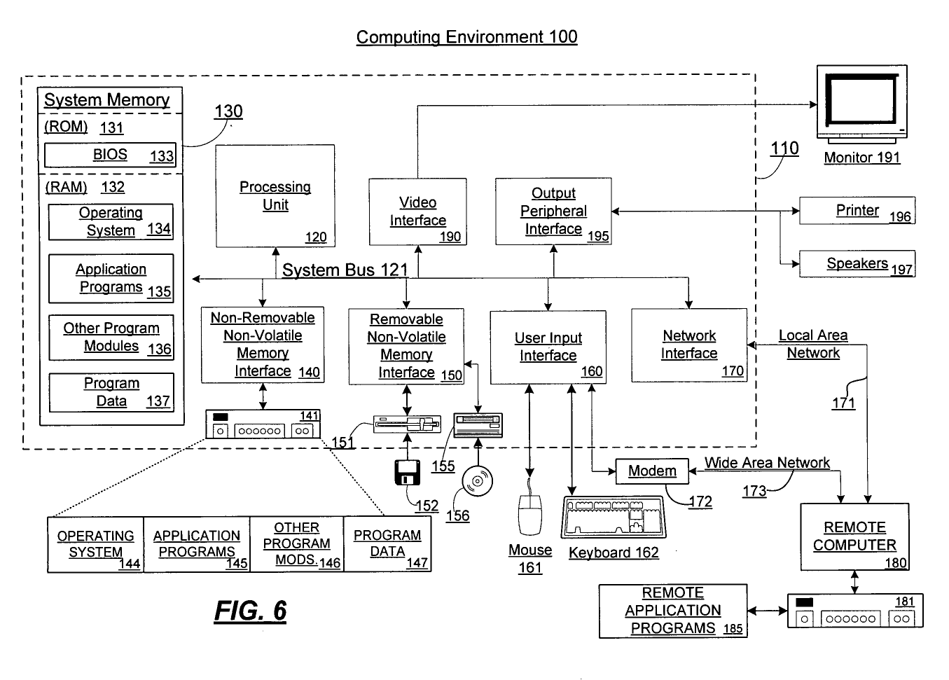

FIG. 6 shows an exemplary computing environment in which example embodiments and aspects may be implemented. The computing system environment 100 is only one example of a suitable computing environment and is not intended to suggest any limitation as to the scope of use or functionality. Neither should the computing environment 100 be interpreted as having any dependency or requirement relating to any one or combination of components illustrated in the exemplary operating environment 100.

Numerous other general purpose or special purpose computing system environments or configurations may be used. Examples of well known computing systems, environments, and/or configurations that may be suitable for use include, but are not limited to, personal computers, server computers, hand-held or laptop devices, multiprocessor systems, microprocessor-based systems, set top boxes, programmable consumer electronics, network PCs, minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 6, an exemplary system includes a general purpose computing device in the form of a computer 110. Components of computer 110 may include, but are not limited to, a processing unit 120, a system memory 130, and a system bus 121 that couples various system components including the system memory to the processing unit 120. The processing unit 120 may represent multiple logical processing units such as those supported on a multi-threaded processor. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus). The system bus 121 may also be implemented as a point-to-point connection, switching fabric, or the like, among the communicating devices.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 6 illustrates operating system 134, application programs 135, other program modules 136, and program data 137.

The computer 110 may also include other removable/non-removable, volatile/nonvolatile computer storage media. By way of example only, FIG. 6 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 6, provide storage of computer readable instructions, data structures, program modules and other data for the computer 110. In FIG. 6, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 6. The logical connections depicted in FIG. 6 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 6 illustrates remote application programs 185 as residing on memory device 181. It will be appreciated that the network connections shown are exemplary and other means of establishing a communications link between the computers may be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A signature method, comprising:
hashing a message with a first hash function to generate a first hashed message;
hashing the first hashed message with a second hash function to generate a second hashed message; and
signing the second hashed message.

2. The method of claim 1, wherein the first hash function is a domain extender.

3. The method of claim 1, wherein the first hash function is a TCR (target collision-resistant) hash.

4. The method of claim 1, wherein the second hash function is a random oracle.

5. The method of claim 1, wherein the first hash function is a one-way hash function.

6. The method of claim 1, wherein the second hash function is slower than the first hash function.

7. The method of claim 1, wherein hashing the message with the first hash function comprises hashing the message M with an independently keyed TCR (target collision-resistant) hash function Hₖ to generate the first hashed message (Hₖ(M)), and wherein hashing the hashed message with a second hash comprises hashing (Hₖ(M)) with a random oracle hash function F to generate the second hashed message (F(Hₖ(M))).

8. The method of claim 7, wherein signing the second hashed message comprises signing (F(Hₖ(M))) with a randomly generated key k to generate a signed message in the form of {k, Sign(F(k, Hₖ(M))} or {k, Sign(F(Hₖ(M))}.

9. The method of claim 1, wherein signing the second hashed message uses a DSA, PSS-RSA, or Cramer-Shoup signature scheme.

10. A computer-readable medium having stored thereon a data structure, comprising:
a first hash module to generate a first hashed message;
a second hash module to generate a second hashed message using the first hashed message; and
a signature module to sign the second hashed method.

11. The computer-readable medium of claim 10, wherein the first hash module comprises a hash function that is a domain extender.

12. The computer-readable medium of claim 10, wherein the first hash module comprises a function that is a TCR (target collision-resistant) hash.

13. The computer-readable medium of claim 10, wherein the second hash module comprises a function that is a random oracle.

14. The computer-readable medium of claim 10, wherein the first hash module comprises a one-way hash function.

15. The computer-readable medium of claim 10, wherein the second hash module comprises a hash function that is slower than that comprised within the first hash module.

16. The computer-readable medium of claim 10, wherein the first hash module hashes the message with a first hash function and comprises hashing the message M with an independently keyed TCR (target collision-resistant) hash function Hₖ to generate the first hashed message (Hₖ(M)), and wherein the second hash module hashes the hashed message with a second hash and comprises hashing (Hₖ(M)) with a random oracle hash function F to generate the second hashed message (F(Hₖ(M))).

17. The computer-readable medium of claim 16, wherein the signature module signs the second hashed message and comprises signing (F(Hₖ(M))) with a randomly generated key k to generate a signed message in the form of {k, Sign(F(k, Hₖ(M))} or {k, Sign(F(Hₖ(M))}.

18. The computer-readable medium of claim 10, wherein the signature module uses a DSA, PSS-RSA, or Cramer-Shoup signature scheme.

19. A signature system, comprising:
an input device that receives a message; and
a processor that hashes the message with a domain extender hash function to generate a first hashed message, hashes the first hashed message with a random oracle hash function to generate a second hashed message, and signs the second hashed message.

20. The system of claim 19, wherein the domain extender hash function is a TCR (target collision-resistant) hash, and the random oracle hash function is slower than the domain extender hash function.
